(19) United States
(12) Patent Application Publication
(10) Pub. No.: US 2026/0124773 A1
(43) Pub. Date: May 7, 2026

(54) MANIPULATOR AND ROBOT COMPRISING THE SAME

(71) Applicant: ABB SCHWEIZ AG, Baden (CH)

(72) Inventors: Jonas Haulin, Shanghai (CN); Kangjian Wang, Shanghai (CN); Ziwei Gao, Zhongshan, Guangdong (CN)

(21) Appl. No.: 19/426,419

(22) Filed: Dec. 19, 2025

Related U.S. Application Data
(63) Continuation of application No. PCT/CN2023/101291, filed on Jun. 20, 2023.

(51) Int. Cl. B25J 19/00; B25J 9/00

(52) U.S. Cl. CPC B25J 19/0029; B25J 9/0009

(57) ABSTRACT

Embodiments of present disclosure relate to a manipulator. The manipulator includes a set of axles coupled in series, a last axle in the set of axles including a housing, extending in a first direction and coupled with a previous axle in the set of axles; a first cavity, extending through the housing; and a second cavity, arranged inside the housing and adapted to accommodate a first harness from the previous axle; and a connector, arranged on a first side of the housing, and adapted to connect the first harness with a second harness. The second harness routes through the first cavity to a second side of the housing, to be coupled to a tool coupled with an output part of the last axle.

### FIELD

Embodiments of the present disclosure generally relate to the field of robot, and more particularly, to a manipulator and a robot comprising the same.

### BACKGROUND

A harness is required in most of robot applications. The harness can be used to for example control the motion of a tool in the robot application. The routing of the harness has an important impact on the range of motion of the manipulator and the volume of the manipulator. In general, the routing of the harness can be classified in three types: external routing, internal routing, and the combination thereof.

The external routing occupies additional space around the manipulator. In general, internal routing provides good protection to the harness and less interference to the environment. However, conventional internal routing requires a bigger internal space, resulting in a large volume of the manipulator. Moreover, the internal harness may create motion limitation to the manipulator, resulting in less motion range. The conventional combination of the internal routing and external routing still has defects similar as those of independent internal routing and external routing.

Thus, there is a need for a new approach for overcoming at least partly the defects mentioned above.

### SUMMARY

In view of the foregoing problems, various example embodiments of the present disclosure provide a manipulator and a robot.

In a first aspect, example embodiments of the present disclosure provide a manipulator. The manipulator comprises: a set of axles coupled in series, a last axle in the set of axles comprising: a housing, extending in a first direction and coupled with a previous axle in the set of axles; a first cavity, extending through the housing; and a second cavity, arranged inside the housing and adapted to accommodate a first harness from the previous axle; and a connector, arranged on a first side of the housing, and adapted to connect the first harness with a second harness, wherein the second harness routes through the first cavity to a second side of the housing, to be coupled to a tool coupled with an output part of the last axle.

With such an arrangement, a manipulator with compact volume can be provided, and a flexible motion range setting can be provided for the last axle of the manipulator. Moreover, it is easy for a user to assemble the harness as desired.

In some embodiments, the first cavity comprises a first opening, which is arranged on the first side of the housing adjacent to the connector, and a second opening, which is arranged on the second side of the housing adjacent to the output part.

With such an arrangement, the second harness can be routed through the cavity via the first opening and the second opening, such that the second harness can be easily connected to the tool coupled with the last axle.

In some embodiments, the housing is a ground side of the last axle, and the last axle further comprises the output part, which is coupled with the ground side and configured to hold the tool and rotate relative to the ground side.

With such an arrangement, the second harness can be routed from the connector arranged at a side of the housing through the first cavity to reach the tool coupled at the output part, allowing flexible setting of the second harness.

In some embodiments, the output part is a flange and comprises a central hole, which is extending centrally in the first direction, or a lateral hole, which is arranged at a side of the flange and extending in a second direction perpendicular to the first direction.

With such an arrangement, the second harness can be routed through the first cavity via the central hole or the lateral hole arranged at the flange, allowing for a compact construction of the last axle.

In some embodiments, the second opening is aligned with the central hole. With such an arrangement, a user can easily assemble the second harness.

In some embodiments, the second opening communicates with the central hole or the lateral hole.

With such an arrangement, the second harness can be routed via the second opening and the central hole or the lateral hole to reach the tool, thus enabling a compact construction and a flexible routing.

In some embodiments, the first cavity is cylindrical and arranged centrally in the housing.

With such an arrangement, the first cavity is easy to be fabricated, and facilitates the operation of harness routing.

In some embodiments, the connector is arranged at the first side of the housing adjacent to a moving portion of the previous axle.

With such an arrangement, the length of the first harness exposed outside the manipulator is very short, thereby reducing the occupation of external space.

In some embodiments, the size of the first cavity is configured to allow a connector coupled with the tool to pass through the first cavity.

With such an arrangement, the second harness together with a connector can be easily routed through the second cavity, thereby facilitating user assembly.

In some embodiments, the first harness is routed internally in all previous axles in the set of axles.

With such an arrangement, more external space can be saved.

In a second aspect of the present disclosure, example embodiments of the present disclosure provide a robot comprising a manipulator according to the first aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

The solution of the disclosure provides good flexibility of routing harness of the manipulator, and offers an easy way to assemble the harness.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a perspective view illustrating a manipulator in accordance with an embodiment of the present disclosure;

FIG. 2 is a schematic front view of the manipulator as shown in FIG. 1;

FIG. 3 is a schematic front view of a sixth axle together with a fifth axle of the manipulator in accordance with an embodiment of the present disclosure;

FIG. 4 is a perspective view illustrating a sixth axle of the manipulator in accordance with an embodiment of the present disclosure;

FIG. 5 is a schematic front view of the sixth axle of the manipulator as shown in FIG. 4;

FIG. 6 is a schematic left view of the sixth axle of the manipulator as shown in FIG. 4;

FIG. 7 is a sectional view illustrating the sixth axle of the manipulator as shown in FIG. 6;

FIG. 8 is an perspective view illustrating a manipulator with internal harness in accordance with an embodiment of the present disclosure;

FIG. 9 is a schematic front view of the manipulator with internal harness as shown in FIG. 8;

FIG. 10 is a schematic front view of a sixth axle together with a fifth axle of the manipulator with internal harness in accordance with an embodiment of the present disclosure, and

FIG. 11 is a sectional view illustrating the sixth axle of the manipulator as shown in FIG. 4 with internal harness.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

As mentioned above, in general, the routing of the harness can be classified in three types: internal routing, external routing and the combination thereof. Specifically, the internal routing means that the harness locates inside of the manipulator, and is not visible from outside. The external routing means that the harness locates outside of the manipulator. The combination of internal routing and external routing means that the harness is routed by both internal and external harness routing. The known harness routing is defective.

A typical example of external harness routing is that the harness is routed on a manipulator or a large robot. The harness has complicated bending and torsional movement. Such a scheme limits the range of motion of the manipulator.

In general, internal routing provides good protection to the harness and less interference to the environment. The more harness routed inside the manipulator, the better experience the user will have.

An example of internal routing is that the internal routing stops until a tool flange. The harness to the tool has no movement. The disadvantage is that there is a relative movement of the harness (for example, cable) between a stationary end and a moving end of the last axle inside the manipulator, which strictly limits the range of motion of the last axle. That is, the harness inside the manipulator may impede the movement of the manipulator. Whether the user uses the connector or not, there will be a bundle of harness inside the last axle. The moving harness will be easily broken (in a relatively large range of motion). Since the cables inside the manipulator are part of a robot product, the user cannot adjust them according to their own on-site needs.

Moreover, the known internal routing may lead to a large space inside the manipulator to be occupied, resulting in a larger volume of the manipulator.

External routing typically occupies more external space and limits the movement of the manipulator.

A typical example of internal routing plus external routing is that the harness is routed on a six axes small robot. The internal routing stops after the fourth axle, and the external routing needs to pass the fifth axle and the sixth axle. The external harness to the tool has both bending and torsional movement. As a result, it occupies large space around the robot.

Another example of internal routing plus external routing is a routing of another six axes small robot. The internal harness stops after the fourth axle, then passes along the fifth axle and goes through the sixth axle. The external harness to the tool has both bending and torsional movement. It still occupies some external space around the small robot.

In addition, connectors on a tool flange usually require a tool cabling that requires space and limits working range, because the connectors usually cannot be centered on the tool flange. When there is no motion limitation from kinematic, for example, like the last axle, the harness will create motion limitation which results in less motion range.

Reasonable harness routing helps to reduce the impact on the range of motion of the manipulator and reduce the size of the manipulator.

Therefore, there is a need for a new approach to overcome at least partly the disadvantages of the traditional manipulator.

In view of the forgoing, according to embodiments of the present disclosure, a manipulator is provided in the present invention.

The manipulator may comprise a set of axles coupled in series. A last axle in the set of axles comprises a housing, a first cavity, a second cavity and a connector. The housing extends in a first direction X and is coupled with a previous axle in the set of axles. The first cavity extends through the housing. The second cavity is arranged inside the housing and adapted to accommodate a first harness from the previous axle. The connector is arranged on a first side of the housing, and adapted to connect the first harness with a second harness, wherein the second harness routes through the first cavity to a second side of the housing, to be coupled to a tool coupled with an output part of the last axle.

With such an arrangement, a manipulator with compact volume can be provided, and a flexible motion range setting can be provided for the last axle of the manipulator. Moreover, it is easy for a user to assemble the harness as desired.

The above idea may be implemented in various manners, as will be described in detail in the following paragraphs.

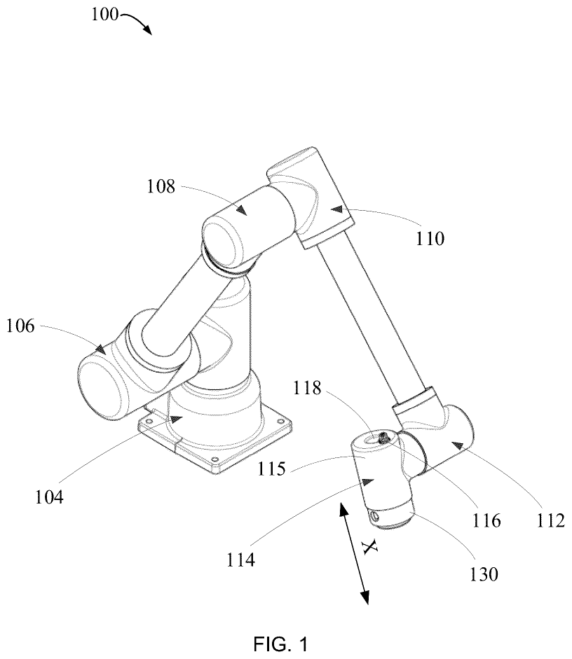

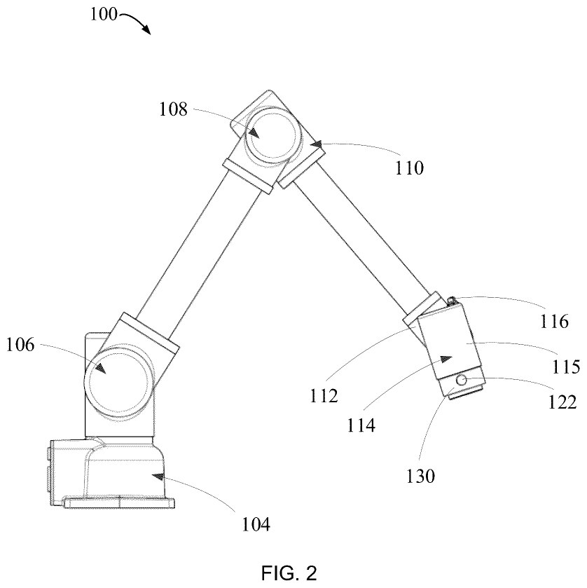

Hereinafter, the principles of the present disclosure will be described in detail with reference to FIGS. 1-11. Referring to FIGS. 1 to 2 first, wherein FIG. 1 is a perspective view illustrating a manipulator in accordance with an embodiment of the present disclosure; and FIG. 2 is a schematic front view of the manipulator as shown in FIG. 1.

In some embodiments, as shown in FIG. 1 and FIG. 2, the manipulator 100 generally includes a set of axles coupled in series. In particular, the manipulator 100 as shown in FIG. 1 is an example of a six axes manipulator. The manipulator 100 may include: a first axle 104, which also acts as the base of the manipulator 100; a second axle 106, coupled with the first axle 104; a third axle 108, coupled with the second axle 106; a fourth axle 110, coupled with the third axle 108; a fifth axle 112, coupled with the fourth axle 110; and a sixth axle 114, coupled with the fifth axle 112. As is well known for those skilled in the art, each of the set of axles includes a ground side (stationary part) and a mobile side (mobile part). A mobile side of a previous axle is coupled with a ground side of a next axle. For clarity, the ground side and mobile side of each axle are not specifically marked with reference numerals in FIGS. 1 and 2.

As can be seen from FIGS. 1 and 2, the sixth axle 114 is the last axle of this manipulator 100. The rest of the axles (the first to fifth axles) may be considered as the main body of the manipulator 100.

In some embodiments, a six axes manipulator is taken as an example for description. It is to be understood that the scope of the present disclosure is not intended to be limited in this respect. The solution of the present disclosure can be applied to a manipulator with any number of axes.

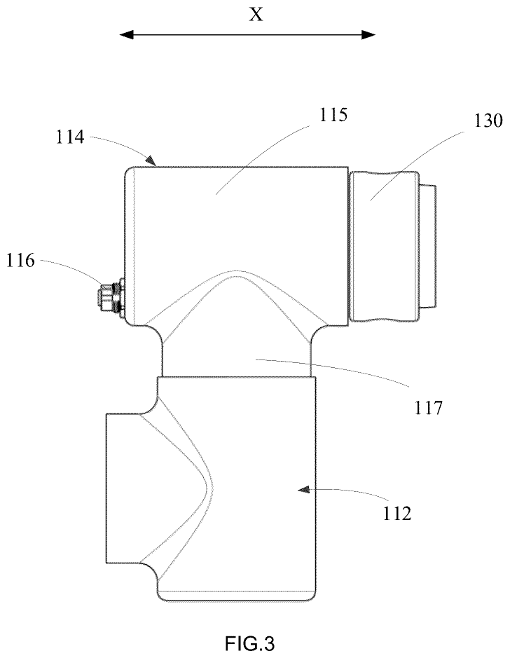

The sixth axle 114 will now be further described with reference to FIG. 3 to FIG. 7.

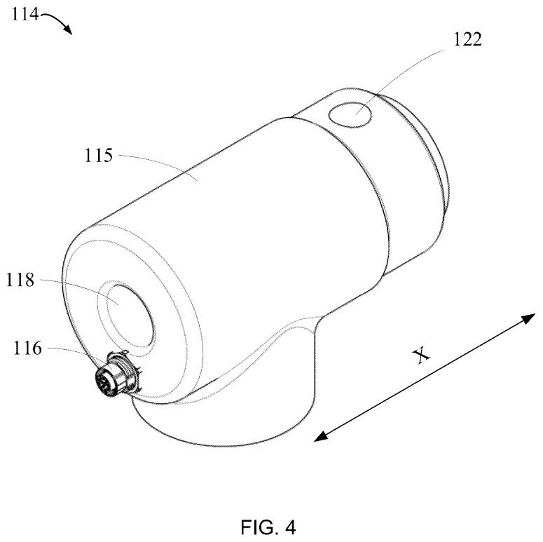

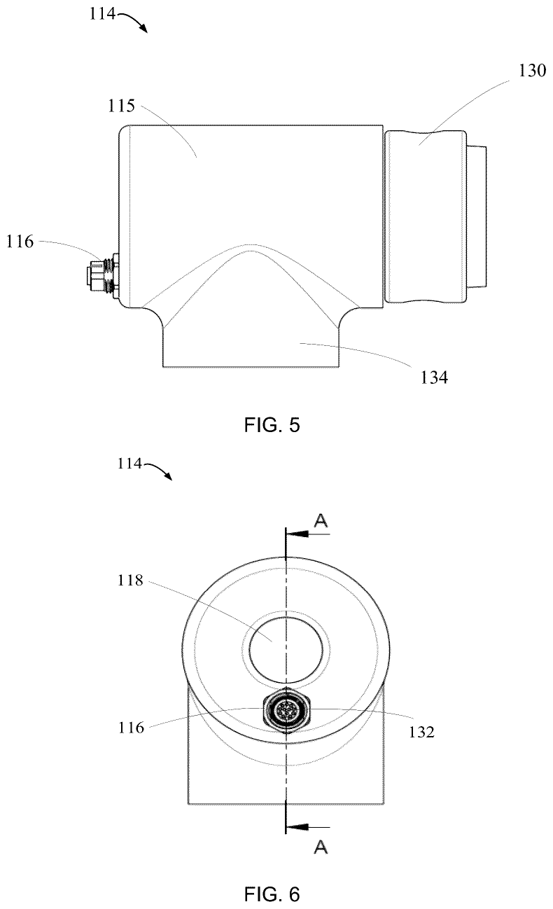

Referring to FIG. 3 and FIG. 5 first, FIG. 3 is a schematic front view of a sixth axle together with a fifth axle of the manipulator in accordance with an embodiment of the present disclosure. FIG. 4 is a perspective view illustrating a sixth axle of the manipulator in accordance with an embodiment of the present disclosure. FIG. 5 is a schematic front view of the sixth axle of the manipulator as shown in FIG. 4.

As shown in FIG. 3 to FIG. 5, the sixth axle 114 comprises a housing 115. The housing 115 extends in a first direction X and is coupled with a previous axle in the set of axles. Specifically, the housing 115 is coupled with the mobile side 117 of the fifth axle 112.

The housing 115 is a ground side of the last axle 114. In some embodiments, the sixth axle 114 further comprises an output part 130. The output part 130 is coupled with the ground side and configured to hold the tool, for example, a gripper. The output part 130 is a mobile part and thus is rotatable relative to the ground side.

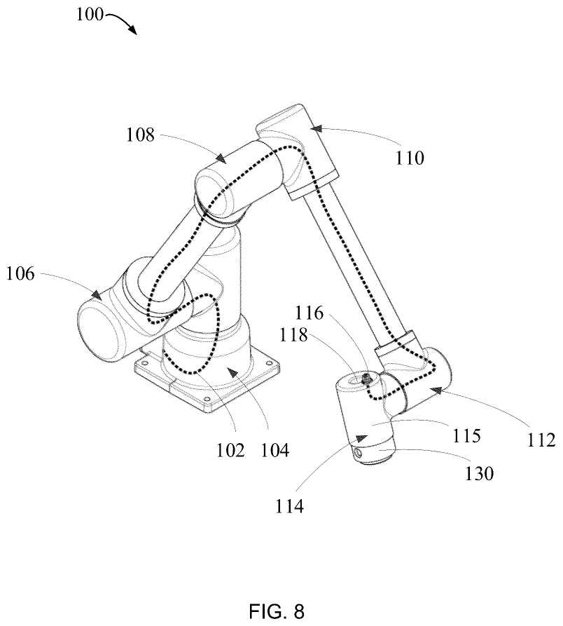

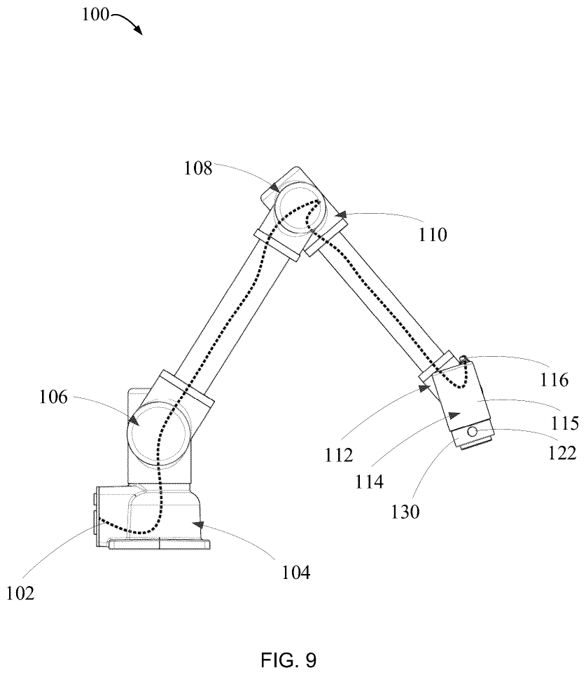

A connector 116 is arranged on a first side of the housing 115, for example, on a side perpendicular to the axis thereof. The connector 116 is adapted to connect the first harness 102 (referring to FIGS. 8 and 9) routing through the fifth axle 112 with a second harness 103, wherein the second harness 103 is routed through the first cavity 118 to a second side of the housing 115, for example, opposite to the first side, to be coupled to a tool coupled with the sixth axle 114.

In some embodiments, the connector 116 may be an electric connector, such as a power line connector, a signal line connector; or a pneumatic connector, such as an air hose connector.

In some embodiments, there may be several connectors 116, arranged on the same or different sides of the housing 115. Each of the several connectors 116 may be an electric connector or a pneumatic connector.

The power line connector may be used to supply power to the tool. The signal line connector may be used to feed back the actual position, current, torque, and/or other parameter information of the gripper to a robot controller for information recording, control, and analysis. The air hose connector may be used to supply air to the tool for start-up. The connector 116 can also be sensor interfaces such as visual sensors/torque sensors, etc.

Accordingly, the first harness 102 may include power lines, signal lines, and air hoses. A first end of the first harness 102 is located inside the housing 115, and may be connected with the connector 116. A second end of the first harness 102 may be connected to a connector (not shown) arranged in the first axle 104. A first end of the second harness 103 connects with the connector 116. The second end of the second harness 103 may be routed through the first cavity 118. The second end of the second harness 103 may be connected to a tool such as a gripper coupled with the output part 130 of the last axle 114.

As can be seen from FIG. 3 to FIG. 5, the connector 116 is arranged at a side of the housing 115 perpendicular to the axis of the housing 115. It is to be understood that the scope of the present disclosure is not intended to be limited in this respect. Other configuration is also possible. In fact, the connector 116 may be arranged at any side of the housing 115.

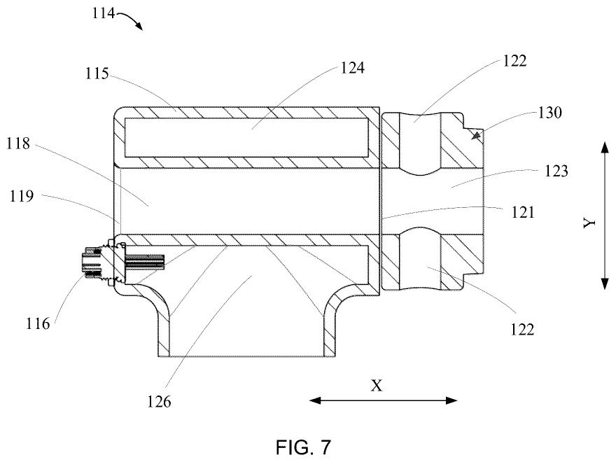

The sixth axle 114 will be further described with respect to FIG. 6 and FIG. 7.

FIG. 6 is a schematic left view of the sixth axle of the manipulator as shown in FIG. 4; and FIG. 7 is a sectional view illustrating the sixth axle of the manipulator as shown in FIG. 6.

Referring now to FIG. 6 to FIG. 7, the first cavity 118 is cylindrical and arranged centrally in the housing 115. In this way, the first cavity is easy to be fabricated, and facilitates the operation or harness routing. The connector 116 may include a pin 132. The pin 32 may be used to connect power lines or signal lines in the first harness 102 and in the second harness 103. It is to be understood that the scope of the present disclosure is not intended to be limited in this respect. The connector 116 may have other structures. For example, as mentioned above, the connector 116 may be an air hose connector.

As shown in FIG. 7, the first cavity 118 comprises a first opening 119 and a second opening 121. The first opening 119 is arranged on the first side of the housing 115 adjacent to the connector 116; and the second opening 121 is arranged on the second side of the housing 115 adjacent to the output part 130. In some embodiments, as shown in FIG. 7, the second opening 121 is arranged on the second side of the housing 115 and abuts against a side of the output part 130.

The first cavity 118 extends through the housing 115. The second cavity 126 is arranged inside the housing 115, and adapted to accommodate a first harness 102 from the previous axle. The first harness 102 may be routed from the first axle 104 and reach the housing 115 of the sixth axle 114 via a second cavity 126 inside the fifth axle 112.

In some embodiments, the output part 130 is a flange. As shown in FIG. 7, the flange includes a central hole 123 and/or a lateral hole 122. The central hole 123 extends centrally in the first direction X. The lateral hole 122 is arranged at a side of the flange and extending in a second direction Y perpendicular to the first direction X.

In some embodiments, the second opening 121 communicates with the central hole 123 or the lateral hole 122. In this way, the second harness 103 can be routed through the central hole 123 or the lateral hole 122 to connect to a tool, for example, a pneumatic/electric gripper, suction cups, etc.

In some embodiments, the second opening 121 is aligned with the central hole 123. That is, the second harness 103 can be routed through the first cavity 118 and directly routed out of the central hole 123.

As shown in FIG. 7, the first cavity 118 is cylindrical and arranged centrally in the housing 115. It is to be understood that the scope of the present disclosure is not intended to be limited in this respect. Other configuration is also possible. In fact, the first cavity 118 may be constructed to have other shapes and/or include different structures therein.

As shown in FIG. 7, the housing 115 further includes a third cavity 124. The third cavity 124 may contain some other components, such as drive components such as motors, reducers, etc.

As can be seen from FIG. 3 to FIG. 7, the connector 116 is arranged at a side of the housing 115 adjacent to a moving portion of the previous axle. The size of the first cavity 118 is configured to allow a connector coupled with the tool to pass through the first cavity 118. For example, the diameter of the first cavity 118 is configured to be as large as possible, which will be valuable for customers. Enlarged cavity will allow more harness to pass through the first cavity 118, thereby preventing from having to wrap harness from outside the manipulator 100.

Usually, a larger first cavity 118 can strengthen the advantages of the present invention. If it is difficult to pass through a connector within a smaller cavity, or it can only pass through less harness, it will be inconvenient to a user. If the first cavity 118 is larger than the conventional one, the advantages will be more obvious. In the present invention, the first cavity 118 of the sixth axle 114 is relatively large. The limitation of the large size here is that a motor and a reducer with a larger hollow hole are required. In the invention, a motor and reducer with a larger hollow hole is used. The hollow hole can be used as the first cavity 118.

If the harness 102 and/or the harness 103 are routed outside the manipulator 100, it will affect the range of motion when the manipulator 100 moves in a narrow space. Moreover, when a user does not require the second harness 103, the sixth axle 114 can rotate without limit, because there will be no moving harness between the stationary part and the mobile part of the sixth axle 114 to limit the range of motion.

The routing of the harness will be further described with reference to FIGS. 8 to 10.

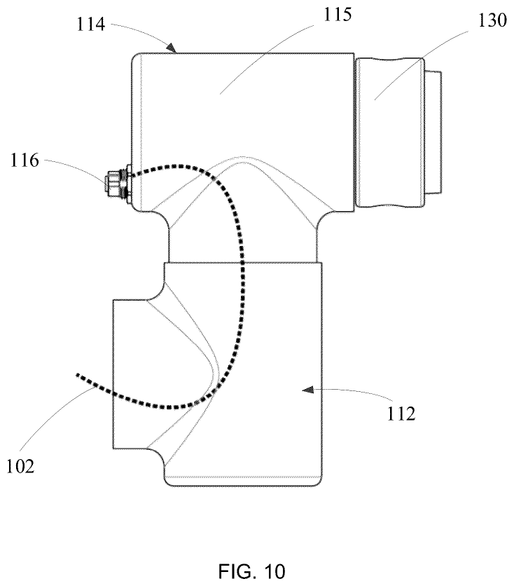

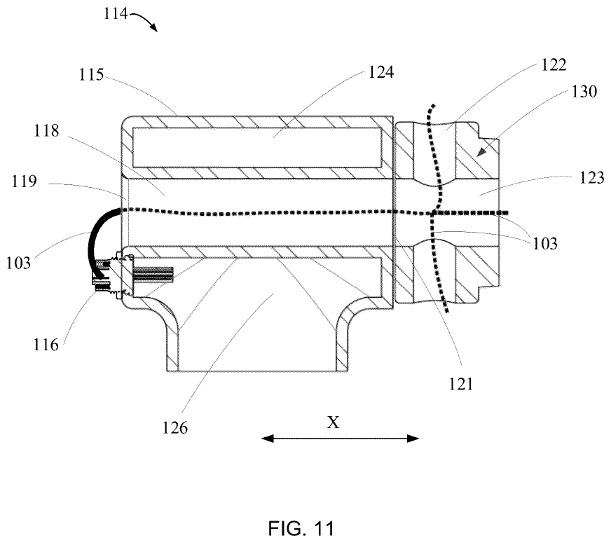

FIG. 8 is an perspective view illustrating a manipulator with internal harness in accordance with an embodiment of the present disclosure; FIG. 9 is a schematic front view of the manipulator as shown in FIG. 8; and FIG. 10 is a schematic front view of a sixth axle together with a fifth axle of the manipulator with internal harness in accordance with an embodiment of the present disclosure, and FIG. 11 is a sectional view illustrating the sixth axle of the manipulator as shown in FIG. 4 with internal harness.

In some embodiments, as shown in FIG. 8 and FIG. 9, the first harness 102 is routed internally from the first axle 102 and stops at the connector 116. In this way, more external space can be saved.

As shown in FIG. 10, the first harness 102 is routed through the fifth axle 112 and enters the housing 115 and connects with the connector 116.

As shown in FIG. 11, the second harness 103 is routed through the central hole 123 or the lateral hole 122. FIG. 11 illustrates a particular configuration of the sixth axle 114. It is to be understood that the scope of the present disclosure is not intended to be limited in this respect. Other configuration is also possible. In fact, the central hole 123 and the lateral hole 122 can be arranged in other ways. Moreover, the connector 116 may be arranged at any side of the housing 115.

In some embodiments, as shown in FIGS. 8 and 9, the first harness 102 is routed inside all the previous axles before the sixth axle 114. It is to be understood that the scope of the present disclosure is not intended to be limited in this respect. Other configuration is also possible. For example, a part of the first harness 102 may be routed around some of the previous axles.

The manipulator 100 of the present disclosure has unique advantages. At present, there is no similar product in the market. The invention overcomes the disadvantages of the traditional manipulator and has the following advantages.

The volume of the manipulator 100 of the invention is compact, and a flexible motion range setting can be provided for the last axle of the manipulator 100. Moreover, it is easy for a user to assemble the harness. In addition, it allows a very large motion range when the harness is not required or limited.

A further advantage of the invention is that there is no relative movement of harness inside the manipulator 100 between the stationary par and the mobile part of the last axle. When the user does not need to use the connector 116, in other words, does not need to use the second harness 103, the last axle can freely rotate at an unlimited angle. When the user needs to use the connector 116, the user can install a section of harness between the connector 116 and the tool and freely adjust the length of the second harness 103 according to actual needs to meet requirements. Thus, the user has a higher degree of freedom.

The present disclosure further provides a robot. The robot comprises a manipulator as described in previous embodiments.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A manipulator comprising:
a set of axles coupled in series, a last axle in the set of axles comprising:
a housing, extending in a first direction and coupled with a previous axle in the set of axles;
a first cavity, extending through the housing; and
a second cavity, arranged inside the housing and adapted to accommodate a first harness from the previous axle; and
a connector, arranged on a first side of the housing, and adapted to connect the first harness with a second harness, wherein the second harness routes through the first cavity to a second side of the housing, to be coupled to a tool coupled with an output part of the last axle.

2. The manipulator according to claim 1, wherein the first cavity comprises:
a first opening, arranged on the first side of the housing adjacent to the connector; and
a second opening, arranged on the second side of the housing adjacent to the output part.

3. The manipulator according to claim 2, wherein the housing is a ground side of the last axle, and the last axle further comprises:
the output part, coupled with the ground side, and configured to hold the tool and rotate relative to the ground side.

4. The manipulator according to claim 3, wherein the output part is a flange and comprises:
a central hole, extending centrally in the first direction; or
a lateral hole, arranged at a side of the flange and extending in a second direction perpendicular to the first direction.

5. The manipulator according to claim 4, wherein the second opening is aligned with the central hole.

6. The manipulator according to claim 4, wherein the second opening communicates with the central hole or the lateral hole.

7. The manipulator according to claim 1, wherein:
the first cavity is cylindrical and arranged centrally in the housing.

8. The manipulator according to claim 1, wherein the connector is arranged at the first side of the housing adjacent to a moving portion of the previous axle.

9. The manipulator according to claim 1, wherein the size of the first cavity is configured to allow a connector coupled with the tool to pass through the first cavity.

10. The manipulator according to claim 1, wherein the connector is an electric connector or a pneumatic connector.

11. The manipulator according to claim 1, wherein the last axle comprises at least one the connector, each arranged on the same side or different sides of the housing.

12. The manipulator according to claim 1, wherein the first harness is routed internally in all previous axles in the set of axles.

13. A robot comprising the manipulator according to claim 1.
